(19) United States
(12) Patent Application Publication
(10) Pub. No.: US 2025/0046915 A1
(43) Pub. Date: Feb. 6, 2025

(54) BATTERY

(71) Applicant: ZHUHAI COSMX BATTERY CO., LTD., Zhuhai (CN)

(72) Inventors: Zhida WEI, Zhuhai (CN); Jichun XIE, Zhuhai (CN)

(73) Assignee: ZHUHAI COSMX BATTERY CO., LTD., Zhuhai (CN)

(21) Appl. No.: 18/925,623

(22) Filed: Oct. 24, 2024

Related U.S. Application Data
(63) Continuation of application No. PCT/CN2023/114672, filed on Aug. 24, 2023.

(30) Foreign Application Priority Data
Oct. 8, 2022 (CN) 202222655933.7

(51) Int. Cl. H01M 50/103; H01M 50/184; H01M 50/188; H01M 50/342; H01M 50/503; H01M 50/557; H01M 50/636

(52) U.S. Cl. CPC H01M 50/103; H01M 50/184; H01M 50/188; H01M 50/3425; H01M 50/503; H01M 50/557; H01M 50/636

(57) ABSTRACT

A battery includes a first half housing, a second half housing and an arc-shaped battery cell. The first half housing and the second half housing are connected to enclose and form an arc-shaped accommodating cavity that matches the arc-shaped battery cell, and the arc-shaped battery cell is accommodated in the arc-shaped accommodating cavity. Disposal of the arc-shaped accommodating cavity enables a structure of an aluminum laminated film housing to match a structure of an arc-shaped battery cell, so as to facilitate an operation of encapsulating the arc-shaped battery cell in the aluminum laminated film housing, and to improve an effect of fixing the arc-shaped battery cell in the aluminum laminated film housing, thereby reducing a probability of the arc-shaped battery cell moving relative to the aluminum laminated film housing, and thus achieving an technical effect of improving a safety of an arc-shaped battery.

### CROSS-REFERENCE TO RELATED APPLICATIONS

This application is a continuation of International Application No. PCT/CN2023/114672, filed on Aug. 24, 2023, which claims priority to Chinese Patent Application No. 202222655933.7, filed on Oct. 8, 2022. The disclosures of the aforementioned applications are hereby incorporated by reference in their entireties.

### TECHNICAL FIELD

The present disclosure relates to the field of battery technologies, and in particular, to a battery.

### BACKGROUND

Wearable electronic products need to use arc-shaped batteries (which may be understood as batteries formed by arc-shaped electrode plates). Currently, an aluminum laminated film housing manufactured by the related technologies has a cubic structure, not suitable for an arc-shaped structure of an arc-shaped battery cell, such that the aluminum laminated film housing manufactured by the related technologies has a poor effect for fixing the arc-shaped battery cell therein, thereby resulting in that the arc-shaped battery manufactured by the related technologies is poor in safety.

### SUMMARY

The purposes of embodiments of the present disclosure are to provide a battery, for solving a problem of a poor safety of an arc-shaped battery manufactured by the related technologies.

Embodiments of the present disclosure provide a battery, including: a first half housing, a second half housing and an arc-shaped battery cell, the first half housing and the second half housing are connected to enclose and form an arc-shaped accommodating cavity that matches the arc-shaped battery cell, and the arc-shaped battery cell is accommodated in the arc-shaped accommodating cavity.

Optionally, the first half housing includes a first arc-shaped plate opposite to the second half housing, and the second half housing includes a second arc-shaped plate opposite to the first half housing; and a first arc face, close to the first half housing, of the arc-shaped battery cell is opposite to the first arc-shaped plate, and a second arc face, close to the second half housing, of the arc-shaped battery cell is opposite to the second arc-shaped plate.

Optionally, the first half housing includes an annular first flange plate, the second half housing includes an annular second flange plate, and the first flange plate and the second flange plate are connected to seal the arc-shaped accommodating cavity.

Optionally, in a case that the first half housing is convex in a direction away from the second half housing, and in a direction from the second half housing to the first half housing, a distance between a tangent plane, farthest from the second half housing, of the first arc-shaped plate and a plane where the first flange plate is located is greater than or equal to 2 mm.

Optionally, in a case that the second half housing is concave towards the first half housing, and in a direction from the second half housing to the first half housing, a distance between a tangent plane, nearest to the first half housing, of the second arc-shaped plate and a plane where the second flange plate is located is greater than or equal to 0.3 mm.

Optionally, a difference between a radian corresponding to the first arc-shaped plate and a radian corresponding to the second arc-shaped plate is greater than or equal to 0 and is less than or equal to 10 degrees.

Optionally, one of the first half housing and the second half housing is provided with a liquid injection hole, and a sealing part is disposed in the liquid injection hole by means of a sealing manner.

Optionally, one of the first half housing and the second half housing is provided with a post terminal hole, a conductive part is disposed in the post terminal hole by means of a sealing manner, and the conductive part passes through an end of the post terminal hole to be electrically connected to a tab of the arc-shaped battery cell.

Optionally, in a case that the first half housing is convex in a direction away from the second half housing and the second half housing is concave towards the first half housing, the first half housing is provided with a post terminal hole and a liquid injection hole on an end face of the first half housing.

Optionally, the conductive part includes a post terminal and a connection piece; and the post terminal passes through the post terminal hole and protrudes into the arc-shaped accommodating cavity, and an end, protruding into the arc-shaped accommodating cavity, of the post terminal is electrically connected to the tab of the arc-shaped battery cell via the connection piece.

Optionally, the conductive part further includes an inner insulating pad and an outer insulating pad, and the post terminal includes an inner end and an outer end; and a first face, close to the arc-shaped battery cell, of the connection piece is connected to the tab of the arc-shaped battery cell and the inner end by means of an abutting connection, respectively.

Optionally, the inner insulating pad is located between a second face, away from the arc-shaped battery cell, of the connection piece and an inner surface of the first half housing where the post terminal hole is located; or the inner insulating pad is located between a second face, away from the arc-shaped battery cell, of the connection piece and an inner surface of the second half housing where the post terminal hole is located.

Optionally, the outer insulating pad is located between the outer end and an outer surface of the first half housing where the post terminal hole is located; or the outer insulating pad is located between the outer end and an outer surface of the second half housing where the post terminal hole is located.

Optionally, an orthographic projection, on the outer insulating pad, of the outer end is located in the outer insulating pad; an orthographic projection, on the inner insulating pad, of the inner end is located in the inner insulating pad; and an orthographic projection, on the inner insulating pad, of the connection piece is located in the inner insulating pad.

Optionally, the conductive part further includes a coupling piece; a first face, close to the arc-shaped battery cell, of the coupling piece is connected to the tab of the arc-shaped battery cell by means of an abutting connection; and a second face, away from the arc-shaped battery cell, of the coupling piece is connected to a first face, close to the arc-shaped battery cell, of the connection piece by means of an abutting connection.

Optionally, the inner insulating pad is provided with a first avoiding groove at an end, close to the first half housing where the post terminal hole is located, of the inner insulating pad; or the inner insulating pad is provided with a first avoiding groove at an end, close to the second half housing where the post terminal hole is located, of the inner insulating pad.

Optionally, the connection piece is provided with a second avoiding groove at an end, close to the first half housing where the post terminal hole is located, of the connection piece; or the connection piece is provided with a second avoiding groove at an end, close to the second half housing where the post terminal hole is located, of the connection piece.

Optionally, the outer insulating pad includes an insulating tube portion passing through the post terminal hole and an annular extending portion located at an end, away from the arc-shaped battery cell, of the insulating tube portion; and in a direction from the inner end to the outer end, the insulating tube portion has a thickness equal to one of the below thicknesses: a sum of a thickness of the extending portion, a thickness of the inner insulating pad and a thickness of the first half housing where the post terminal hole is located; and a sum of a thickness of the extending portion, a thickness of the inner insulating pad and a thickness of the second half housing where the post terminal hole is located.

Optionally, the first half housing is provided with a first pressure-relief region and a first non-pressure-relief region on an end face of the first half housing, and a thickness of the first pressure-relief region is less than a thickness of the first non-pressure-relief region.

Optionally, the second half housing is provided with a second pressure-relief region and a second non-pressure-relief region on an end face of the second half housing, and a thickness of the second pressure-relief region is less than a thickness of the second non-pressure-relief region.

The above technical solutions have the following advantages or beneficial effects. In the embodiments of the present disclosure, disposal of the arc-shaped accommodating cavity enables a structure of an aluminum laminated film housing to match a structure of an arc-shaped battery cell, so as to facilitate an operation of encapsulating the arc-shaped battery cell in the aluminum laminated film housing, and to improve an effect of fixing the arc-shaped battery cell in the aluminum laminated film housing, thereby reducing a probability of the arc-shaped battery cell moving relative to the aluminum laminated film housing, and thus achieving an technical effect of improving a safety of an arc-shaped battery. Moreover, adopting the above arrangement can also enable a space in an aluminum laminated film housing to be fully utilized by an arc-shaped battery cell, which enables an arc-shaped battery to maintain a relatively high energy density.

### BRIEF DESCRIPTION OF THE DRAWINGS

FIG. 1 is an exploded view of a battery according to an embodiment of the present disclosure.

FIG. 2 is a schematic diagram of a first half housing according to an embodiment of the present disclosure.

FIG. 3 is a schematic diagram of a second half housing according to an embodiment of the present disclosure.

FIG. 4 is a first schematic structural diagram of a battery according to an embodiment of the present disclosure.

FIG. 5 is a second schematic structural diagram of a battery according to an embodiment of the present disclosure.

FIG. 6 is a section view at A-A in FIG. 5.

FIG. 7 is a schematic enlarged diagram at B in FIG. 6.

FIG. 8 is a schematic diagram of a post terminal according to an embodiment of the present disclosure.

FIG. 9 is a schematic diagram of an inner insulating pad and a connection piece according to an embodiment of the present disclosure.

### DETAILED DESCRIPTION OF THE EMBODIMENTS

Hereinafter, the technical solutions in the embodiments of the present disclosure will be described clearly and completely in combination with the accompanying drawings of the present disclosure. Apparently, the described embodiments are some embodiments of the present disclosure, rather than all embodiments. Based on the embodiments in the present disclosure, any other embodiments obtained by those skilled in the art without inventive work will be within the protection scope of the present disclosure.

Currently, an aluminum laminated film housing manufactured by the related technologies has a cubic structure, not suitable for an arc-shaped structure of an arc-shaped battery cell, such that the aluminum laminated film housing manufactured by the related technologies has a poor effect for fixing the arc-shaped battery cell therein. Therefore, in practical applications for an arc-shaped battery, an arc-shaped battery cell is prone to move relative to an aluminum laminated film housing, thereby resulting in a higher probability of firing or other problems caused by short-circuiting between positive and negative electrodes in the battery cell. That is, an arc-shaped battery manufactured by the related technologies is poor in safety.

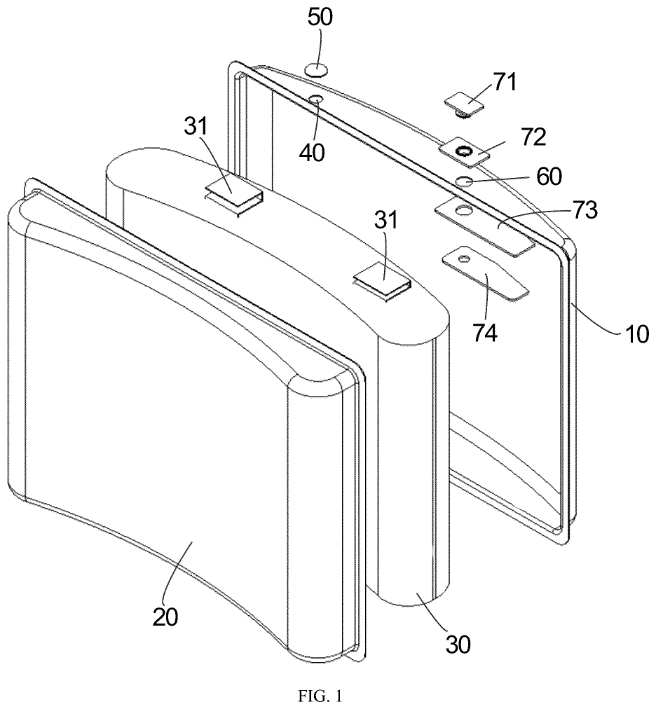

Referring to FIG. 1, FIG. 1 is a schematic structural diagram of a battery according to an embodiment of the present disclosure. As shown in FIG. 1, the battery includes: a first half housing 10, a second half housing 20 and an arc-shaped battery cell 30, the first half housing 10 and the second half housing 20 are connected to enclose and form an arc-shaped accommodating cavity that matches the arc-shaped battery cell 30, and the arc-shaped battery cell 30 is accommodated in the arc-shaped accommodating cavity.

Exemplarily, each of the first half housing 10 and the second half housing 20 may be understood as an aluminum laminated film housing. The first half housing 10 and the second half housing 20 are joined together to form the above-mentioned arc-shaped accommodating cavity.

As above, disposal of the arc-shaped accommodating cavity enables a structure of an aluminum laminated film housing to match a structure of the arc-shaped battery cell 30, so as to facilitate an operation of encapsulating the arc-shaped battery cell 30 in the aluminum laminated film housing, and to improve an effect of fixing the arc-shaped battery cell in the aluminum laminated film housing, thereby reducing a probability of the arc-shaped battery cell 30 moving relative to the aluminum laminated film housing, and thus achieving an technical effect of improving a safety of an arc-shaped battery. Moreover, adopting the above arrangement can also enable a space in an aluminum laminated film housing to be fully utilized by the arc-shaped battery cell 30, which enables an arc-shaped battery to maintain a relatively high energy density.

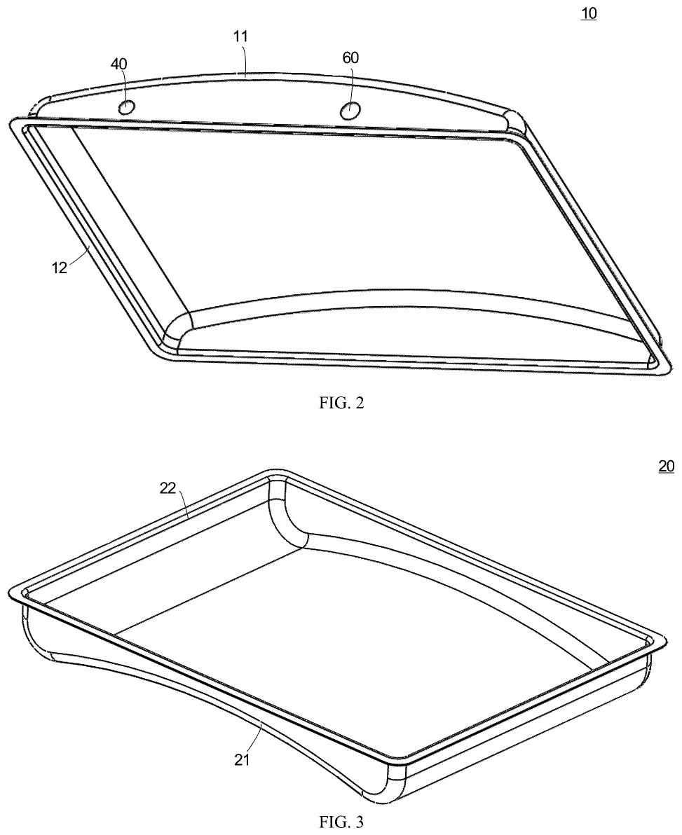

Optionally, as shown in FIG. 2 and FIG. 3, the first half housing 10 includes a first arc-shaped plate 11 opposite to the second half housing 20, and the second half housing 20 includes a second arc-shaped plate 21 opposite to the first half housing 10.

A first arc face of the arc-shaped battery cell 30 is opposite to the first arc-shaped plate 11, and a second arc face of the arc-shaped battery cell is opposite to the second arc-shaped plate 21.

Convex stamping and concave stamping are performed on two aluminum laminated film half housings in the related technologies, respectively, so that the first arc-shaped plate 11 and the second arc-shaped plate 21 according to the embodiments of the present disclosure can be formed. That is, by the above manners of stamping, it is possible to form an arc-shaped accommodating cavity suitable for structural characteristics of the arc-shaped battery cell 30, with an aluminum laminated film maintaining a relatively small thickness and without changing a manufacturing processing of the aluminum laminated film (i.e. additionally adding a stamping process after the above-mentioned made aluminum laminated film half housings are obtained), thus effectively improving manufacturing efficiency of the first half housing 10 and the second half housing 20.

It is necessary to be noted that the above-mentioned arc-shaped battery cell 30 may be understood as a battery cell formed by a plurality of arc-shaped electrode plates in a stacking manner or a winding manner. The arc-shaped battery cell 30 includes the first arc face and the second arc face that are arranged away from each other, the first arc face is opposite to the first arc-shaped plate 11, and the second arc face is opposite to the second arc-shaped plate 21.

Optionally, the first half housing 10 includes an annular first flange plate 12, the second half housing 20 includes an annular second flange plate 22, and the first flange plate 12 and the second flange plate 22 are connected to seal the arc-shaped accommodating cavity.

Further, a maximum distance between a plane where the first arc-shaped plate 11 is located and a plane where the first flange plate 12 is located is greater than or equal to 2 mm; and/or a minimum distance between a plane where the second arc-shaped plate 21 is located and a plane where the second flange plate 22 is located is greater than or equal to 0.3 mm.

The above-mentioned first flange plate 12 and second flange plate 22 may be understood for increasing a contact area between the first half housing 10 and the second half housing 20, thus facilitating sealing processing to the first half housing 10 and the second half housing 20.

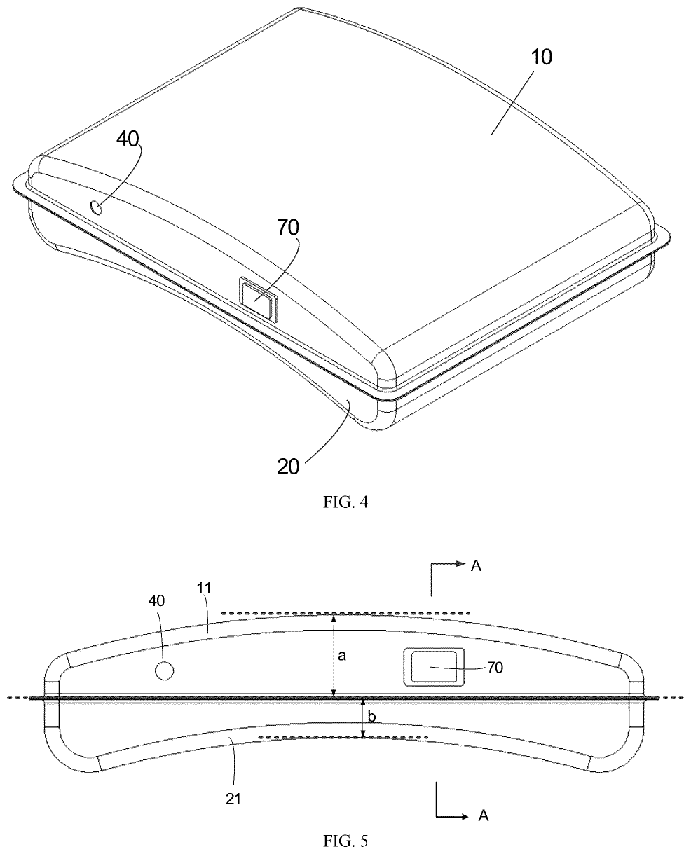

As shown in FIG. 4 and FIG. 5, the maximum distance (i.e. the distance indicated by the parameter a in FIG. 5) between the plane where the first arc-shaped plate 11 is located and the plane where the first flange plate 12 is located is defined as being greater than or equal to 2 mm, which can ensure that an arc face of the first arc-shaped plate 11 has a radian sufficiently matching the first arc face. For the same reason, the minimum distance (i.e. the distance indicated by the parameter b in FIG. 5) between the plane where the second arc-shaped plate 21 is located and the plane where the second flange plate 22 is located is defined as being greater than or equal to 0.3 mm, which can ensure that an arc face of the second arc-shaped plate 21 has a radian sufficiently matching the second arc face.

The radian of the arc face of the first arc-shaped plate 11 matching that of the first arc face may be understood as: a distance between an inner arc face of the first arc-shaped plate 11 and the first arc face being constant in all positions. The radian of the arc face of the second arc-shaped plate 21 matching that of the second arc face may be understood as: a distance between an inner arc face of the second arc-shaped plate 21 and the second arc face being constant in all positions.

Optionally, a difference between the radian corresponding to the first arc-shaped plate 11 and the radian corresponding to the second arc-shaped plate 21 is greater than or equal to 0 and is less than or equal to 10 degrees.

As described above, the difference between the radian corresponding to the first arc-shaped plate 11 and the radian corresponding to the second arc-shaped plate 21 is limited as being within a range of 0 to 10 degrees, so as to avoid a problem of mismatching with the two arc faces of the arc-shaped battery cell 30 due to an over-large difference between the radian corresponding to the first arc-shaped plate 11 and the radian corresponding to the second arc-shaped plate 21, thus ensuring that the arc-shaped battery cell 30 can be well fixed and limited after being placed in the arc-shaped accommodating cavity, and also ensuring that a formed arc-shaped battery can have a relatively high energy density.

The radian corresponding to the first arc-shaped plate 11 may be understood as a radian of the arc face where the first arc-shaped plate 11 is located. For the same reason, the radian corresponding to the second arc-shaped plate 21 may be understood as a radian of the arc face where the second arc-shaped plate 21 is located.

Optionally, as shown in FIG. 1 and FIG. 4, one of the first half housing 10 and the second half housing 20 is provided with a liquid injection hole 40, and a sealing part 50 is disposed in the liquid injection hole 40 by means of a sealing manner; one of the first half housing 10 and the second half housing 20 is provided with a post terminal hole 60, a conductive part 70 is disposed in the post terminal hole 60 by means of a sealing manner, and the conductive part 70 passes through an end of the post terminal hole 60 to be electrically connected to a tab 31 of the arc-shaped battery cell 30.

As shown in FIG. 1, after the arc-shaped battery cell 30 is placed in the arc-shaped accommodating cavity, the liquid injection hole 40 is pre-reserved, which is convenient to operate to inject an electrolyte into the arc-shaped accommodating cavity. After injection of the electrolyte, the liquid injection hole 40 is closed through the sealing part 50, to prevent leakage of the electrolyte and intrusion of external harmful matters (such as dust, or moisture) into the arc-shaped accommodating cavity.

The post terminal hole 60 can cooperate with the conductive part 70 to achieve leading-out for the tab 31 of the arc-shaped battery cell 30.

It is necessary to be noted that in practical applications, both the liquid injection hole 40 and the post terminal hole 60 may be provided on the first half housing 10; or, both the liquid injection hole 40 and the post terminal hole 60 may be provided on the second half housing 20; or, the liquid injection hole 40 is provided on the first half housing 10 and the post terminal hole 60 is provided on the second half housing 20; or, the liquid injection hole 40 is provided on the second half housing 20 and the post terminal hole 60 is provided on the first half housing 10.

In a case that both the liquid injection hole 40 and the post terminal hole 60 are provided on a target half housing, the liquid injection hole 40 and the post terminal hole 60 may both be provided on a same end face of the target half housing, or may also be provided on different end faces of the target half housing, respectively. The target half housing may be understood as the first half housing 10 or the second half housing 20.

Optionally, the first half housing 10 is convex in a direction away from the second half housing 20, the second half housing 20 is concave towards the first half housing 10, and the first half housing 10 is provided with both the post terminal hole 60 and the liquid injection hole 40 on an end face of the first half housing 10.

In the present disclosure, the first half housing 10 may be understood as a half housing formed by convex stamping on an aluminum laminated film half housing, and the second half housing 20 may be understood as a half housing formed by concave stamping on an aluminum laminated film half housing. As the first half housing 10 has an end face area greater than an end face area of the second half housing 20, in a preferred embodiment, both the post terminal hole 60 and the liquid injection hole 40 are selectively provided on the end face of the first half housing 10, to prevent the second half housing 20 having a relatively small end face area from interfering arrangement of the post terminal hole 60 or the liquid injection hole 40.

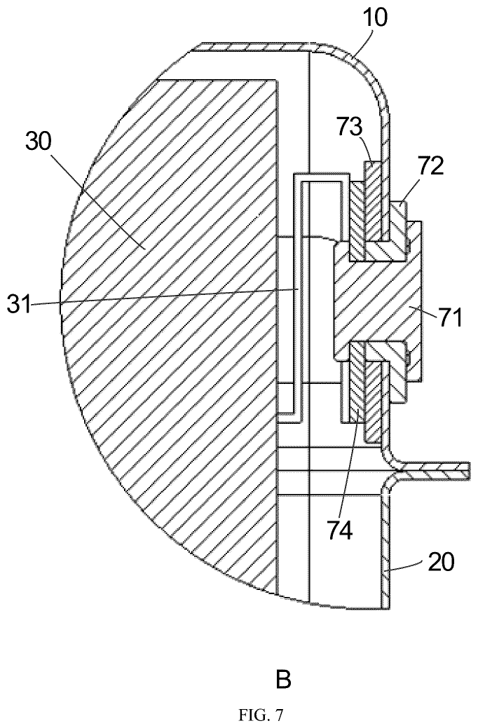

Optionally, as shown in FIG. 1, FIG. 4 and FIG. 7, the conductive part 70 includes a post terminal 71 and a connection piece 74; the post terminal 71 passes through the post terminal hole 60 and protrudes into the arc-shaped accommodating cavity, and an end, protruding into the arc-shaped accommodating cavity, of the post terminal 71 is electrically connected to the tab 31 of the arc-shaped battery cell 30 via the connection piece 74.

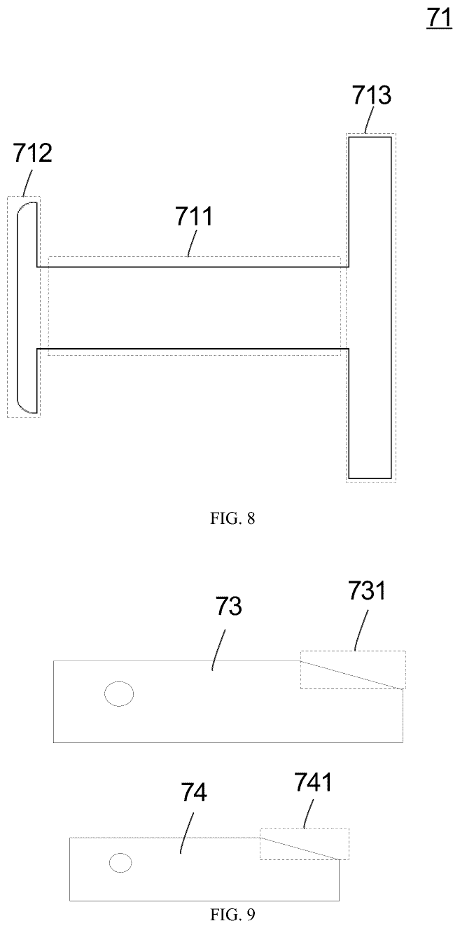

Further, as shown in FIG. 4, FIG. 7 and FIG. 8, the conductive part 70 further includes an inner insulating pad 73 and an outer insulating pad 72, and the post terminal 71 includes an inner end 712 and an outer end 713; a first face of the connection piece 74 is connected to the tab 31 of the arc-shaped battery cell 30 and the inner end 712 by means of an abutting connection, respectively. The inner insulating pad 73 is located between a second face of the connection piece 74 and an inner surface of a target half housing, the outer insulating pad 72 is located between the outer end 713 and an outer surface of a target half housing, and the target half housing is the first half housing 10 or the second half housing 20.

The inner end 712 has a diameter greater than a diameter of a column portion 711, and the outer end 713 has a diameter greater than a diameter of the column portion 711.

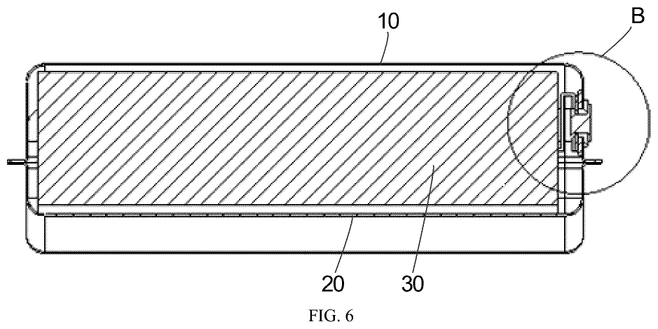

As shown in FIG. 6 and FIG. 7, the outer insulating pad 72 is butted to the outer surface of the target half housing, and the inner insulating pad 73 is butted to the inner surface of the target half housing. The outer insulating pad 72 and the inner insulating pad 73 cooperate with each other, to separate the post terminal 71 from the target half housing, thus preventing a short-circuiting problem due to inter-contact of the post terminal 71 and the target half housing.

Disposal of the connection piece 74, on one hand, is to increase a contact area between the inner end 712 of the post terminal 71 and the tab 31 of the arc-shaped battery cell 30, to ensure stability of electrical connection between the post terminal 71 and the tab 31 of the arc-shaped battery cell 30, and on the other hand, is to cooperate with the inner insulating pad 73 and the outer insulating pad 72, so that the post terminal 71 is fixed on the target half housing in a riveting manner.

Exemplarily, as shown in FIG. 1, FIG. 7 and FIG. 8, the outer insulating pad 72 includes an insulating tube portion and an annular extending portion provided at an end of the insulating tube portion, and the insulating tube portion passes through the post terminal hole 60. An outer surface of the insulating tube portion is butted to an inner wall of the post terminal hole 60, an outer surface of the column portion 711 is butted to an inner surface of the insulating tube portion, and the outer end 713 of the post terminal 71 is connected to a face, away from the arc-shaped battery cell 30, of the extending portion (i.e. a second face of the outer insulating pad 72) by means of an abutting connection.

It is necessary to be noted that on the premise of ensuring an effect of fixing the post terminal 71 on the target half housing, in order to make an arc-shaped battery have a relatively high energy density, or in order to fully utilize a limited space in an arc-shaped battery to obtain a relatively sufficient placing space for the arc-shaped battery cell 30 in the arc-shaped accommodating cavity, a thickness of the insulating tube portion may be defined as a sum of a thickness of the extending portion, a thickness of the inner insulating pad 73 and a thickness of the target half housing.

A first face of the connection piece 74 has a portion of region in contact with the tab 31 of the arc-shaped battery cell 30, and has another portion of region in contact with the inner end 712 of the post terminal 71, to achieve electrical connection between the post terminal 71 and the tab 31 of an arc-shaped battery.

It is necessary to be noted that an electrode plate for forming the arc-shaped battery cell 30 is also arc-shaped, and a radian of the arc-shaped battery cell 30 is kept consistent with a radian of the electrode plate forming the arc-shaped battery cell 30, but a portion of the tab 31 that extends outwards from the electrode plate is in a plane shape.

Optionally, an orthographic projection, on the outer insulating pad 72, of the outer end 713 is located in the outer insulating pad 72, an orthographic projection, on the inner insulating pad 73, of the inner end 712 is located in the inner insulating pad 73, and an orthographic projection, on the inner insulating pad 73, of the connection piece 74 is located in the inner insulating pad 73.

Adopting the above arrangement can ensure that the outer end 713 of the post terminal 71 is sufficiently separated from an outer surface of the target half housing through the outer insulating pad 72, and also ensure that the inner end 712 of the post terminal 71 and the connection piece 74 are sufficiently separated from an inner surface of the target half housing through the inner insulating pad 73, thus preventing a short-circuiting problem due to inter-contact of the post terminal 71 and the target half housing.

Optionally, as shown in FIG. 7 and FIG. 9, the inner insulating pad 73 is provided with a first avoiding groove 731 at an end, close to the first half housing 10, of the inner insulating pad 73; and/or, the connection piece 74 is provided with a second avoiding groove 741 at an end, close to the first half housing 10, of the connection piece 74.

Providing the first avoiding groove 731 on the inner insulating pad 73 may be understood as follows: the inner insulating pad 73 is reduced at an arc-shaped region, close to the arc-shaped accommodating cavity, of the inner insulating pad 73 (i.e. an end of the first half housing 10), and a reduced portion of the inner insulating pad 73 forms the above-mentioned first avoiding groove 731, so that the arc-shaped region of the arc-shaped accommodating cavity can be avoided, thus enabling the inner insulating pad 73 to be smoothly placed in the arc-shaped accommodating cavity.

For the same reason, providing the second avoiding groove 741 on the connection piece 74 may be understood as follows: the connection piece 74 is reduced at an arc-shaped region, close to the arc-shaped accommodating cavity, of the connection piece 74 (i.e. an end of the first half housing 10), and a reduced portion of the connection piece 74 forms the above-mentioned second avoiding groove 741, so that the arc-shaped region of the arc-shaped accommodating cavity can be avoided, thus enabling the connection piece 74 to be smoothly placed in the arc-shaped accommodating cavity.

Optionally, the conductive part 70 further includes a coupling piece; a first face, close to the arc-shaped battery cell 30, of the coupling piece is connected to the tab 31 of the arc-shaped battery cell 30 by means of an abutting connection, and a second face, away from the arc-shaped battery cell 30, of the coupling piece is connected to a first face, close to the arc-shaped battery cell 30, of the connection piece 74 by means of an abutting connection.

As described above, in a case that the arc-shaped battery cell 30 includes a plurality of tabs, the tabs 31 of the arc-shaped battery cell 30 are parts formed from pre-reserved inner tab portions of a plurality of electrode plates by welding, rubbing and pressing, thereby resulting in a relatively poor surface smoothness of the tabs 31 of the arc-shaped battery cell 30, and thus leading to problems such as false soldering when the tabs 31 are welded to the connection piece 74. In contrast, in the embodiments of the present disclosure, the tabs 31 of the arc-shaped battery cell 30 are bent, and the U-shaped coupling piece is welded to a concave region formed by bending of the tabs 31, so that a false soldering problem due to a poor surface smoothness of the tabs 31 of the arc-shaped battery cell 30 may be avoided. That is, the coupling piece having a better smoothness is used, as an extended portion of the tab 31 of the arc-shaped battery cell 30, to be welded to the connection piece 74, so as to ensure stable connection formed between the tabs 31 of the arc-shaped battery cell 30 and the connection piece 74, thereby decreasing a possibility of a problem of poor contact due to false soldering of an arc-shaped battery, and thus lowering a defective rate of a manufactured arc-shaped battery.

Optionally, the first half housing 10 is provided with a first pressure-relief region and a first non-pressure-relief region on an end face of the first half housing 10, and a thickness of the first pressure-relief region is less than a thickness of the first non-pressure-relief region; and/or the second half housing 20 is provided with a second pressure-relief region and a second non-pressure-relief region on an end face of the second half housing 20, and a thickness of the second pressure-relief region is less than a thickness of the second non-pressure-relief region.

As above, an end face of the first half housing 10 is thinned by laser processing or the like (a thinned region is the above-mentioned first pressure-relief region, and a region without thinning is the above-mentioned first non-pressure-relief region), so that in a case that there is a high pressure in the arc-shaped accommodating cavity, high-pressure gas in the arc-shaped accommodating cavity can be released via the first pressure-relief region, to prevent explosion of an arc-shaped battery, thus ensuring a usage safety of the arc-shaped battery.

For the same reason, the end face of the second half housing 20 is thinned, and a thinned region is the above-mentioned second pressure-relief region. The purpose for providing the second pressure-relief region is the same as that for the first pressure-relief region, which will not be repeatedly described any more.

Though the embodiments of the present disclosure have been described as above in combination with the accompanying drawings, the present disclosure is not limited to the above specific embodiments. The above embodiments are exemplary only, and are not for limitation. With the hints of the present disclosure and without departing from the gist of the present disclosure and the protection scope of the claims, those skilled in the art can make several other forms which will be within the protection scope of the present disclosure.

What is claimed is:

1. A battery, comprising: a first half housing, a second half housing and an arc-shaped battery cell, wherein the first half housing and the second half housing are connected to enclose and form an arc-shaped accommodating cavity that matches the arc-shaped battery cell, and the arc-shaped battery cell is accommodated in the arc-shaped accommodating cavity.

2. The battery according to claim 1, wherein the first half housing comprises a first arc-shaped plate opposite to the second half housing, and the second half housing comprises a second arc-shaped plate opposite to the first half housing; and
a first arc face, close to the first half housing, of the arc-shaped battery cell is opposite to the first arc-shaped plate, and a second arc face, close to the second half housing, of the arc-shaped battery cell is opposite to the second arc-shaped plate.

3. The battery according to claim 2, wherein the first half housing comprises an annular first flange plate, the second half housing comprises an annular second flange plate, and the first flange plate and the second flange plate are connected to seal the arc-shaped accommodating cavity.

4. The battery according to claim 3, wherein in a case that the first half housing is convex in a direction away from the second half housing, and in a direction from the second half housing to the first half housing, a distance between a tangent plane, farthest from the second half housing, of the first arc-shaped plate and a plane where the first flange plate is located is greater than or equal to 2 mm.

5. The battery according to claim 3, wherein in a case that the second half housing is concave towards the first half housing, and in a direction from the second half housing to the first half housing, a distance between a tangent plane, nearest to the first half housing, of the second arc-shaped plate and a plane where the second flange plate is located is greater than or equal to 0.3 mm.

6. The battery according to claim 2, wherein a difference between a radian corresponding to the first arc-shaped plate and a radian corresponding to the second arc-shaped plate is greater than or equal to 0 and is less than or equal to 10 degrees.

7. The battery according to claim 1, wherein one of the first half housing and the second half housing is provided with a liquid injection hole, and a sealing part is disposed in the liquid injection hole by means of a sealing manner.

8. The battery according to claim 1, wherein one of the first half housing and the second half housing is provided with a post terminal hole, a conductive part is disposed in the post terminal hole by means of a sealing manner, and the conductive part passes through an end of the post terminal hole to be electrically connected to a tab of the arc-shaped battery cell.

9. The battery according to claim 1, wherein in a case that the first half housing is convex in a direction away from the second half housing and the second half housing is concave towards the first half housing, the first half housing is provided with a post terminal hole and a liquid injection hole on an end face of the first half housing.

10. The battery according to claim 8, wherein the conductive part comprises a post terminal and a connection piece; and
the post terminal passes through the post terminal hole and protrudes into the arc-shaped accommodating cavity, and an end, protruding into the arc-shaped accommodating cavity, of the post terminal is electrically connected to a tab of the arc-shaped battery cell via the connection piece.

11. The battery according to claim 10, wherein the conductive part further comprises an inner insulating pad and an outer insulating pad, and the post terminal comprises an inner end and an outer end; and
a first face, close to the arc-shaped battery cell, of the connection piece is connected to the tab of the arc-shaped battery cell and the inner end by means of an abutting connection, respectively.

12. The battery according to claim 11, wherein the inner insulating pad is located between a second face, away from the arc-shaped battery cell, of the connection piece and an inner surface of the first half housing where the post terminal hole is located; or
the inner insulating pad is located between a second face, away from the arc-shaped battery cell, of the connection piece and an inner surface of the second half housing where the post terminal hole is located.

13. The battery according to claim 11, wherein the outer insulating pad is located between the outer end and an outer surface of the first half housing where the post terminal hole is located; or
the outer insulating pad is located between the outer end and an outer surface of the second half housing where the post terminal hole is located.

14. The battery according to claim 11, wherein an orthographic projection, on the outer insulating pad, of the outer end is located in the outer insulating pad; an orthographic projection, on the inner insulating pad, of the inner end is located in the inner insulating pad; and an orthographic projection, on the inner insulating pad, of the connection piece is located in the inner insulating pad.

15. The battery according to claim 10, wherein the conductive part further comprises a coupling piece;
a first face, close to the arc-shaped battery cell, of the coupling piece is connected to the tab of the arc-shaped battery cell by means of an abutting connection; and
a second face, away from the arc-shaped battery cell, of the coupling piece is connected to a first face, close to the arc-shaped battery cell, of the connection piece by means of an abutting connection.

16. The battery according to claim 11, wherein the inner insulating pad is provided with a first avoiding groove at an end, close to the first half housing where the post terminal hole is located, of the inner insulating pad; or
the inner insulating pad is provided with a first avoiding groove at an end, close to the second half housing where the post terminal hole is located, of the inner insulating pad.

17. The battery according to claim 11, wherein the connection piece is provided with a second avoiding groove at an end, close to the first half housing where the post terminal hole is located, of the connection piece; or
the connection piece is provided with a second avoiding groove at an end, close to the second half housing where the post terminal hole is located, of the connection piece.

18. The battery according to claim 11, wherein the outer insulating pad comprises an insulating tube portion passing through the post terminal hole and an annular extending portion located at an end, away from the arc-shaped battery cell, of the insulating tube portion; and
in a direction from the inner end to the outer end, the insulating tube portion has a thickness equal to one of the below thicknesses:
a sum of a thickness of the extending portion, a thickness of the inner insulating pad and a thickness of the first half housing where the post terminal hole is located; and
a sum of a thickness of the extending portion, a thickness of the inner insulating pad and a thickness of the second half housing where the post terminal hole is located.

19. The battery according to claim 1, wherein the first half housing is provided with a first pressure-relief region and a first non-pressure-relief region on an end face of the first half housing, and a thickness of the first pressure-relief region is less than a thickness of the first non-pressure-relief region.

20. The battery according to claim 1, wherein the second half housing is provided with a second pressure-relief region and a second non-pressure-relief region on an end face of the second half housing, and a thickness of the second pressure-relief region is less than a thickness of the second non-pressure-relief region.
